(19) United States
(12) Patent Application Publication
(10) Pub. No.: US 2003/0126127 A1
(43) Pub. Date: Jul. 3, 2003

(54) Estimation of join fanout using augmented histogram

(75) Inventor: Abdo Esmail Abdo, Rochester, MN (US)

Correspondence Address: Thomas W. Humphrey, Wood, Herron & Evans, L.L.P., 2700 Carew Tower, 441 Vine Street, Cincinnati, OH, 45202-2917, US

(73) Assignee: INTERNATIONAL BUSINESS MACHINES CORPORATION

(21) Appl. No.: 10/039,369

(22) Filed: Jan. 2, 2002

(51) Int. Cl. G06F 7/00

(52) U.S. Cl. 707/4

(57) ABSTRACT

In processing a query including a selection criterion on one or more attributes of a relation, a join fanout statistic is generated using an equi-width histogram for the join attribute, that is augmented to identify the most frequent values in the join attribute. In this way, a more accurate join fanout statistic may be generated as compared to statistics generated using formulas, with favorable storage and resource consumption as compared to a conventional index.

### FIELD OF THE INVENTION

This invention generally relates to a database management system performed by computers.

### BACKGROUND OF THE INVENTION

Statistics are frequently accumulated to describe data in a database, to facilitate accesses made to the data. For example, when a query seeks records meeting complex selection criteria, the process of assembling the results may be made substantially more efficient by evaluating the selection criteria in an appropriate order. Ordering is important because the process of scanning a database for matching records is time consuming.

For example, consider a database having three tables (otherwise known as relations), a first “identification” table including columns (otherwise known as attributes) identifying vehicle identification numbers and the make, model, and model year of those vehicles, a second “vehicle types” table identifying vehicles by make, model and model year and listing other information about those vehicles, such as their body style, and a third “owners” table including columns identifying vehicle identification numbers and the name and address of the owner.

An exemplary query into these relations may seek to identify vehicle owners having two-seat vehicles, e.g. for the purpose of soliciting those persons for membership in a sports car club. To perform this query, the three tables would need to be joined, the identification and vehicle types tables being joined based upon the make, model and model year attributes (which are in the context of that operation, known as the “join attributes”), and the owners and identification tables being joined based upon the vehicle identification number attribute. Then, the query would select only those rows (otherwise known as tuples) in the resulting table that correspond to two-seat vehicles, and return only the owner name and address attributes from those rows.

This query involves forming the join of two tables and then joining the result with a third table. Execution of this query immediately involves a question of ordering; specifically, whether to join the identifications table with the vehicle types table, and then join the result with the owners table, or alternatively to join the identifications table with the owners table and then join the result with the vehicle types table. The optimal join ordering is typically the order that produces the smallest intermediate result set, i.e., the ordering in which the number of rows resulting from the first join is as small as possible. Unfortunately, the number of rows that result from a join operation, is a function of the number of rows with matching attributes in the two tables, which varies not only with the size of the tables but also with the characteristics of the tuples in the table. In the above example, it may be that the owners table is much larger than the vehicle types table, however, there may be fewer matching attributes between the owners table and the identifications table than there are between the identifications table and the vehicle types table. Or, this may not be the case.

To attempt to optimize query processing, modem database software often generates statistics prior to executing a query, to estimate the likely size of the solution sets that will be generated from each step in executing the query. In the case of table joins, the relevant statistic is “join fanout”, which is a measure of the size of the solution set that will be generated by the join of two tables on one or more identified attributes. Join fanout statistics have in the past been formed by formulas that are based upon the relative sizes of the tables being joined and the number of distinct values in each table. The formula used in the DB2 family of database software sold by the assignee of the application, estimates the join fanout of joining two tables R and S based upon the equi-join predicate R.Y=S.Y (the attribute Y value in a tuple in table R equals the attribute Y value in the table S), according to the formula:

$$T ( R∞S ) = \frac{T ( R ) \times T ( S )}{max ( V ( R , Y ) , V ( S , Y ) )} \qquad ( 1 )$$

Where T(R) and T(S) are the number of tuples (rows) in tables R and S, and V(R,Y) and V(S,Y) are the number of distinct values of the attribute Y in each of tables R and S.

Unfortunately, this and other similar formulas for estimating join fanout are typically based upon one or a number of assumptions that are often incorrect. For example, the formula used in the DB2 family of database software, assumes that every value appearing in one of the joined tables also appears in the other, and that the attributes in each table are uncorrelated.

These assumptions are only likely to be true where the joined attributes hold a primary-foreign key relationship, i.e., when the joined attributes are numeric identifiers arbitrarily assigned to each tuple in the respective relations. These assumptions are not likely to be true when the joined attributes are not key values.

Statistics have also been formed using indexes, such as the encoded vector index (EVI), disclosed U.S. Pat. No. 5,706,495, Chadha et al., Jan. 6, 1998, “Encoded-Vector Indices For Decision Support and Warehousing”, which is incorporated by reference. Other forms of indexes are used in other circumstances, as is found to be efficient for the particular type of data in use. An encoded vector index may be used to create a join fanout statistic, if there are such indexes formed over the join attribute(s) for each joined table. Unfortunately, indexes consume substantial storage space, and maintaining the currency of an index consumes substantial computational resources. Accordingly, in many cases not all attributes of all tables are indexed.

Accordingly, new ways to generate statistics and to index database tables are needed in order to continue to provide significant improvements in query performance; otherwise, database users will be hampered in their ability to maximize intelligent information retrieval.

### SUMMARY OF THE INVENTION

In accordance with principles of the present invention, these needs are met through the use of a method for estimating statistics that is more accurate than a formula based method, but is not computationally expensive. Specifically, an augmented histogram of an attribute of a relation is provided. The histogram is augmented to identify the most frequent values of the attribute. Using this histogram in computing statistics such as join fanout, permits some advance comparison of at least frequent values as part of estimating join fanout.

The above and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a block diagram of a computer system managing a database according to an embodiment of the present invention;

FIGS. 2A and 2B are illustrations of histogram indexes generated for an attribute Y in tables R and S, respectively, in a relational database system in accordance with an embodiment of the present invention;

FIG. 3A is a flow chart of a process of generating a join fanout statistic using histogram indexes such as those shown in FIGS. 2A and 2B, and FIG. 3B is a flow chart of a process of comparing histogram buckets of two such indexes; and

FIG. 4 is a flow chart of a process of generating a histogram index such as those shown in FIGS. 2A and 2B, from a relation being indexed

### DETAILED DESCRIPTION OF SPECIFIC EMBODIMENTS

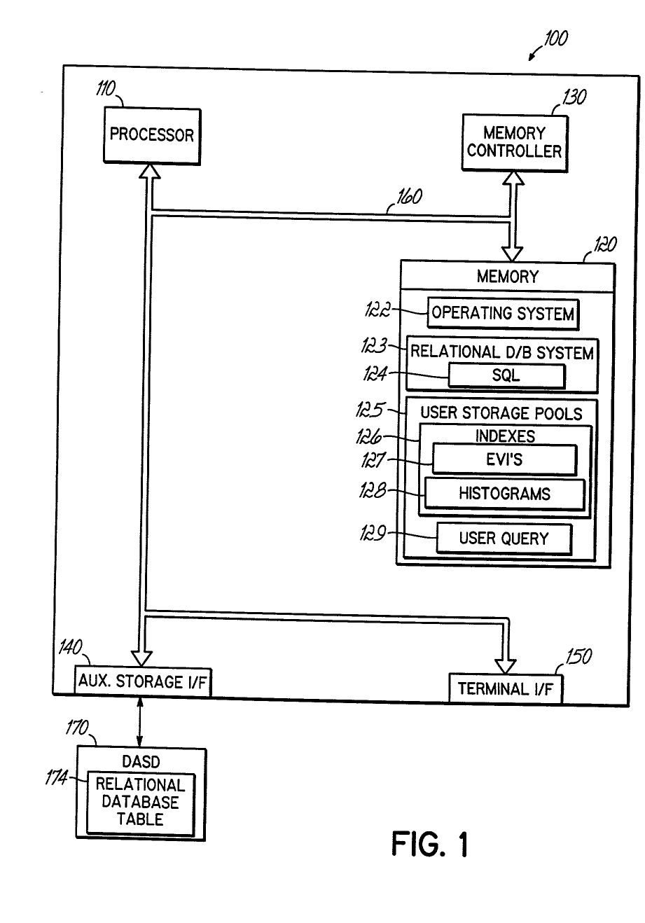

The methods of the present invention employ computer-implemented routines to query information from a database. Referring now to FIG. 1, a block diagram of a computer system which can implement an embodiment of the present invention is shown. The computer system shown in FIG. 1 is an IBM AS/400; however, those skilled in the art will appreciate that the method and apparatus of the present invention apply equally to any computer system, regardless of whether the computer system is a complicated multi-user computing apparatus or a single user device such as a personal computer or workstation. Thus, computer system 100 can comprise other types of computers such as IBM compatible personal computers running OS/2 or Microsoft's Windows. Computer system 100 suitably comprises a processor 110, main memory 120, a memory controller 130, an auxiliary storage interface 140, and a terminal interface 150, all of which are interconnected via a system bus 160. Note that various modifications, additions, or deletions may be made to computer system 100 illustrated in FIG. 1 within the scope of the present invention such as the addition of cache memory or other peripheral devices. FIG. 1 is presented to simply illustrate some of the salient features of an exemplary computer system 100.

Processor 110 performs computation and control functions of computer system 100, and comprises a suitable central processing unit (CPU). Processor 110 may comprise a single integrated circuit, such as a microprocessor, or may comprise any suitable number of integrated circuit devices and/or circuit boards working in cooperation to accomplish the functions of a processor. Processor 110 suitably executes a computer program within main memory 120.

Auxiliary storage interface 140 allows computer system 100 to store and retrieve information such as relational database table or relation 174 from auxiliary storage devices, such as magnetic disk (e.g., hard disks or floppy diskettes) or optical storage devices (e.g., CD-ROM). As shown in FIG. 1, one suitable storage device is a direct access storage device (DASD) 170. DASD 170 may alternatively be a floppy disk drive which may read programs and data such as relational database table 174 from a floppy disk. In this application, the term “storage” will be used to collectively refer to all types of storage devices, including disk drives, optical drives, tape drives, memory etc. It is important to note that while the present invention has been (and will continue to be) described in the context of a fully functional computer system, those skilled in the art will appreciate that the mechanisms of the present invention are capable of being distributed as a program product in a variety of forms, and that the present invention applies equally regardless of the particular type of signal bearing media to actually carry out the distribution. Examples of signal bearing media include: recordable type media such as floppy disks (e.g., a floppy disk) and CD ROMS, and transmission type media such as digital and analog communication links, including wireless communication links.

Memory controller 130, through use of a processor, is responsible for moving requested information from main memory 120 and/or through auxiliary storage interface 140 to processor 110. While for the purposes of explanation, memory controller 130 is shown as a separate entity, those skilled in the art understand that, in practice, portions of the function provided by memory controller 130 may actually reside in the circuitry associated with processor 110, main memory 120, and/or auxiliary storage interface 140.

Terminal interface 150 allows system administrators and computer programmers to communicate with computer system 100, normally through programmable workstations. Although the system 100 depicted in FIG. 1 contains only a single main processor 110 and a single system bus 160, it should be understood that the present invention applies equally to computer systems having multiple buses. Similarly, although the system bus 160 of the embodiment is a typical hardwired, multidrop bus, any connection means that supports-directional communication in a computer-related environment could be used.

In the illustrated embodiment, memory 120 suitably includes an operating system 122, a relational database system 123, and user storage pools 125. Relational database system 123 includes structured query language (SQL) 124, which is an interactive query and report writing interface. Those skilled in the art will realize that SQL 124 could reside independent of relational database system 123, in a separate memory location.

User storage pools 125 include indexes 126 such as an encoded vector index (EVI) 127, and histogram indexes 128 developed in accordance with principles of the present invention, as well as storage for temporary data such as a user query 129. EVI 126 is one example of various forms of index that might be utilized in addition to a histogram index. User query 129 is a request for information from relational database table 174 stored in DASD 170. The methods of the present invention do not require that the entire relational database table be loaded into memory 120 to obtain the information requested in user query 129. Instead, indexes are loaded into memory 120 and provides relational database system 123 an efficient way to obtain the information requested by user query 129.

It should be understood that for purposes of this application, memory 120 is used in its broadest sense, and can include Dynamic Random Access Memory (DRAM), Static RAM (SRAM), flash memory, cache memory, etc. Additionally, memory 120 can comprise a portion of a disk drive used as a swap file. While not explicitly shown in FIG. 1, memory 120 may be a single type of memory component or may be composed of many different types of memory components. For example, memory 120 and CPU 110 may be distributed across several different computers that collectively comprise system 100. It should also be understood that programs in memory 120 can include any and all forms of computer programs, including source code, intermediate code, machine code, and any other representation of a computer program.

Users of relational database system 123 provide requests for information in a useful form by creating user query 129. User query 129 is a way to ask relational database system 123 to provide only the set of information from relational database table 174 that meets certain criteria. Structured Query Language (SQL) 124 is the standard command language used to query relational databases. SQL commands are entered by a user to create user query 129, which then typically undergoes the following front-end processing by relational database system 123. User query 129 is parsed for syntax errors. The relational database table from where the user wants his information is identified. The field name(s) associated with the information are verified to exist in the relational database table. And, the SQL commands in user query 129 are reviewed by optimization software in relational database system 123 to determine the most efficient manner in which to process the user's request.

The front-end optimization processing of user query 129 by relational database system 123 determines whether a particular index exists that might be used more efficiently than another database index or than the relational database housed in DASD 170.

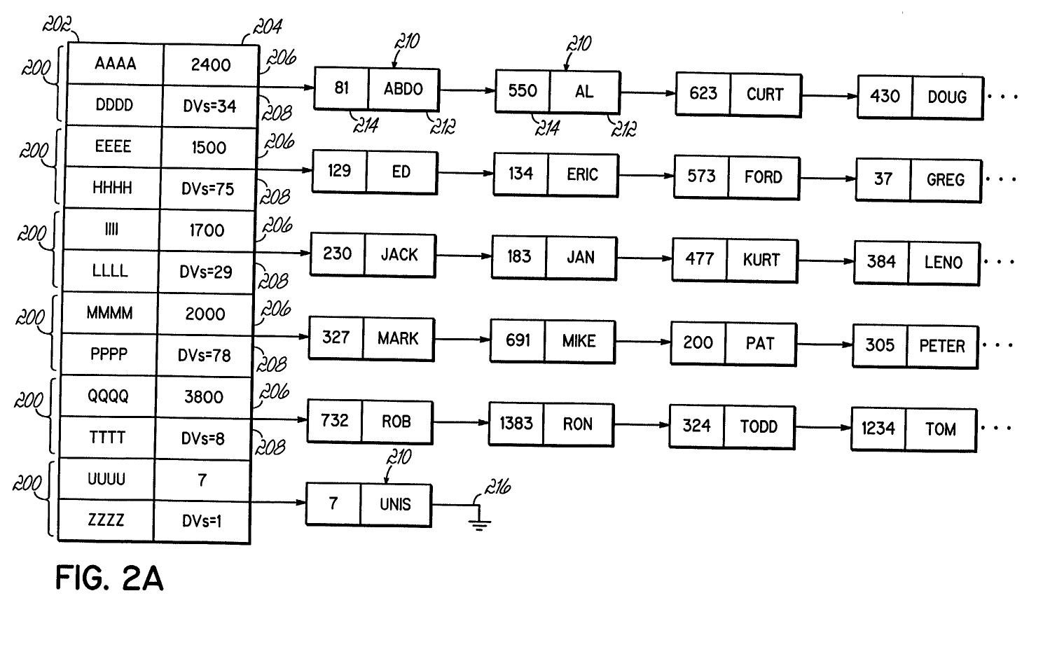

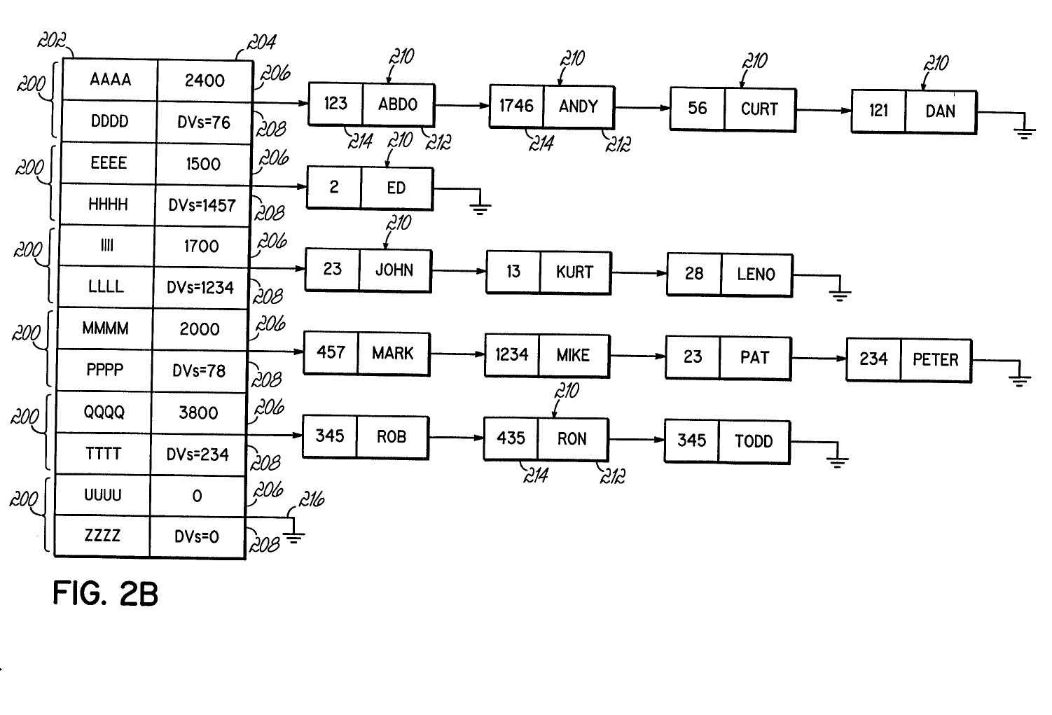

The front end optimization processing of user query 129, utilizes a histogram index of the kind illustrated in FIGS. 2A and 2B. The histogram index is created by collecting a sample of rows from the database table being indexed. Typically a small sample of rows is sufficient to create a reasonably accurate characterization of the entire data sample. The objective of the histogram index is to create reasonably accurate estimates of join fanouts. For this application, a table being indexed is sampled, by collecting a uniformly random sample of rows. For a very large table, a sample of 2000 rows is sufficient for characterizing the entire table. The sampled rows are then sorted based upon the attribute to be indexed, according to a sort order, such as a typical alphanumeric ordering. Then, a histogram is created for the values in each column (attribute) in the table that is to be indexed.

For later reference, the histogram indexes shown in FIGS. 2A and 2B will be described as forming an index for an attribute Y in two tables, R and S, respectively. The attribute Y of table R will be identified as R.Y and the attribute Y of table S will be identified as R.S. This nomenclature will facilitate later descriptions of operations and database predicates such as the join predicate R.Y=S.Y, seeking tuples from R and S having matching values for the attribute Y.

A histogram on an attribute X, is constructed by a partitioning the distribution of values of that attribute into mutually disjoint subsets, which will be referred to as buckets. Then, the number of values and the specific values in each bucket are determined. One approach for selecting the buckets is an assumption of uniform spread, under which the attribute values are assumed to be placed at reasonably equal intervals in the sort order for the attribute, and so the buckets are defined to equally divide the range of possible values in the sorting order. Thus, for example, in an alphabetical sorting order, each bucket may represent, e.g., three letters of the alphabet. An alternative approach is to arrange the buckets so as to approximately equilibrate the number of values that will appear in each bucket. An equi-width histogram is a histogram of the first type, in which each bucket is assigned a value range of equal length; an equi-depth histogram is of the second type, and buckets are assigned the approximately same number of values, and may have substantially greater and smaller value ranges.

Equi-width histograms are used in the following example of an implementation of the present invention. It will be noted that this implementation requires the comparison of corresponding bins from two histogram indexes. This comparison requires that the partitions of the histograms being compared exactly align. That is, the dividing point between bins in the sort order must exactly match. Equi-width histograms utilize a predetermined division of the sorting order and therefore are readily suitable for these methods. Equi-depth histograms typically involve variable width bins, i.e., bins defined by variable dividing points in the sort order. To meet the need for matching bin dividing points, if equi-depth histograms are used, the bin dividing points must be selected so that, in any combination of the resulting histograms, the bin dividing points of the two histograms will have at least some matching dividing points. For example, the sort order may be divided into equally spaced bins, and then each bin may be optionally subdivided along predetermined dividing points as needed to approximately equilibrate the number of values in the bins. Because the bin dividing points are predetermined and will in all cases include at least the dividing points of the initial equally spaced bins, the comparison of two histogram indexes may always proceed because there will always be matching dividing points.

In the example illustrated in FIGS. 2A and 2B, an equi-width/equi-depth histogram has been used for an attribute having alphabetical data values. Specifically, the attribute being indexed is the first names of individuals identified in the table. The exemplary histogram is constructed by sorting this attribute, and dividing the attribute into six alphabetical ranges. The first five ranges correspond to the groups of letters A-D, E-H, I-L, M-P and Q-T. The last range corresponds to the group of letters U-Z. It will be noted that the six buckets divide the alphabetical ordering into five equal width (four letter) buckets, and the last bucket representing the range from U to Z which is slightly larger than the other buckets but which, due to the infrequent use of these letters, is likely to have fewer values per letter as compared to the other buckets. This selection and sizing of buckets is merely exemplary; the number of buckets or ranges used in any given implementation of the present invention may be varied, with greater accuracy and the estimation of join fanout being possible through an increase in the number of buckets defined in the histogram indexes.

Each of the buckets is represented by a data structure 200, as seen in FIG. 2A and FIG. 2B. Each bucket 200 represented in FIG. 2A and FIG. 2B corresponds to an alphabetical range. The alphabetical range for a bucket would typically not be stored separately for each index, but rather would be stored or encoded in one or a few locations in the executable code of the relational database system. Column 202 is included in the illustration of FIGS. 2A and 2B for descriptive purposes, so that the ranges associated with the individual buckets can be readily identified.

Each data structure 200 for a histogram index includes specific values, shown in FIGS. 2A and 2B in column 204. As shown in column 204, each bucket is associated with a first value 206 identifying the number of values of the indexed table's attribute, that fall within the range corresponding to that bucket. Each bucket is further associated with a second value 208 identifying the number of distinct values of the indexed table's attribute, that fall within the range corresponding to the bucket.

Thus, as an illustrative example, the first table (to be identified as table R) used to generate the index in FIG. 2A, included 2400 values in the attribute Y that is indexed by the histogram of FIG. 2A, that fall between A and D in the alphabetical ordering. There are 1500 values that fall in the alphabetical ordering between E and H, and so on. Furthermore, in the table R that was used to generate the histogram index in FIG. 2A, there are 34 distinct values for attribute Y that fall in the alphabetical range between A and D and there are 75 distinct values that fall in the alphabetical range between E and H, and so on.

The data structures for a histogram index in accordance with principles of the present invention include not only the value count and the number of distinct values in fields 206 and 208, but further include a linked list of structures identifying, for each bucket of the histogram, the most frequent values in the bucket. The most frequent values are identified through the use of the sample culled from the table, and the sample size and number of values in the sample is used to approximate the number of each of these most frequent values that appear in the entire table. Each frequent value is characterized by a data structure 210.

Each data structure 210 includes a field 212 setting forth the value, and a field 214 identifying the estimated number of occurrences of that value of the attribute in the table that is indexed by the histogram index. Thus, as seen in FIG. 2A, table R, in the attribute value Y, has a frequent value ABDO, which is estimated to appears 81 times in the attribute Y in the table. Furthermore, this table includes a frequent value AL, which is estimated to appear 550 times in the attribute Y in the table.

The linked list of data structures 210 is formed by pointers. The data structures for a bucket 200 include a pointer to the first structure in the linked list of the structures 210. Each structure 210 includes a pointer to the next structure 210 in the linked list of structures for that bucket. The last structure 210 in a linked list is identified by a null pointer in that data structure, indicating that no further structures exist in the list. This can be seen in FIG. 2A, the last data structure in the linked list for the bucket corresponding to the alphabetic range between U and Z is identified by a null pointer 216 in that data structure. If no frequent values have been identified by a given bucket, then the first pointer has a null value as can be seen in FIG. 2B where there is a null pointer 216 in the last bucket 200 for the range U through Z.

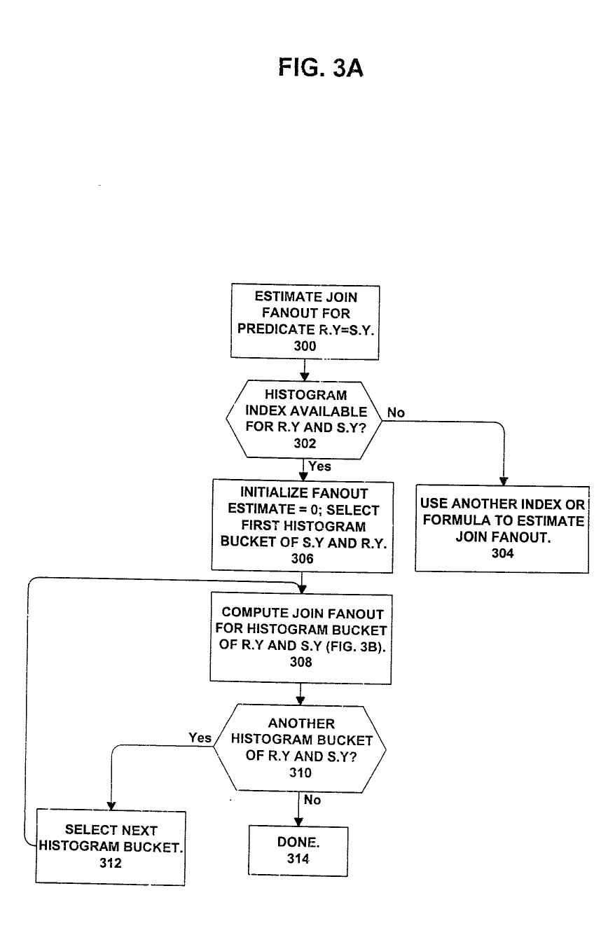

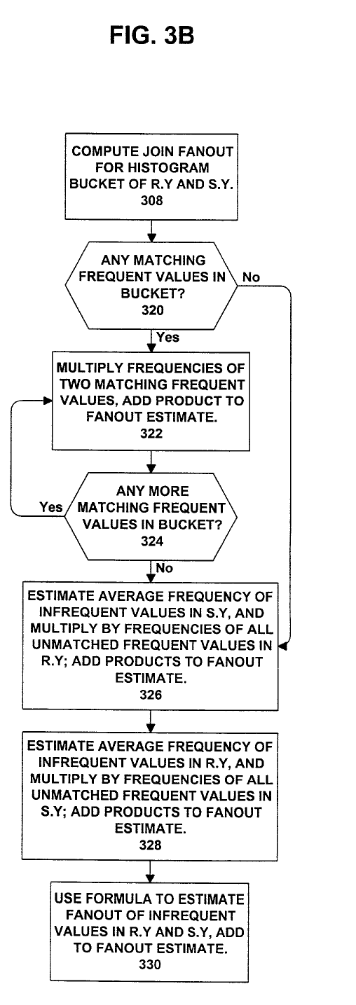

The linked list of data structures 210 is ordered, that is, the structures in the list are sorted in accordance with the sort key used for the attribute being indexed. In this way, the linked list can be more readily searched and compared to other lists, as discussed below with reference to FIGS. 3A and 3B.

Using a linked list approach, an unlimited number of frequent values may be stored for each bucket in the histogram. The number of frequent values to be stored in the histogram may be selected based upon the available storage space. Indexing a larger number of frequent values will increase the accuracy of join fanout estimates, at a corresponding expense in processing time and storage space.

Referring now to FIGS. 3A and 3B, a process for estimating join fanout for a predicate, identified R.Y=S.Y, is explained. This process utilizes histogram indexes such as those illustrated in FIGS. 2A and 2B. Referring to FIG. 3A, the process 300 begins in a step 302 in which it is determined whether a histogram index is available for the attribute Y in both tables R and S that are the subject of the predicate, R.Y=S.Y. If a histogram index is not available for both tables for the identified attribute, processing continues to step 304 in which another index such as an encoded vector index, or a formula such as that described in the background, is used to estimate the join fanout for the predicate.

If, however, there is a histogram index for the attribute Y in both tables R and S, then processing continues from step 302 to step 306, in which the fanout estimate is initialized to have a value of zero. Then the first bucket of each histogram for the attribute Y in tables R and S is selected. A sequence of steps is then performed for each bucket in the respective histogram indexes, to compute the join fanout for the join of the two complete tables.

In a first step 308, the join fanout for a first histogram bucket of table R and table S is computed, and added to the overall fanout estimate. Details of this step 308 are illustrated in FIG. 3B which is discussed below. After computing a join fanout for a current histogram bucket, in step 310 it is determined whether there are additional histogram buckets in the indexes for attribute Y in tables R and S. If so, then in step 312 the next histogram bucket is selected for each index from tables R and S, and processing returns to step 308 to compute the join fanout for that histogram bucket.

Once all histogram buckets for tables R and S have been evaluated, an overall estimate for join fanout has been computed, and the process of FIG. 3A is done in step 314.

Referring to FIG. 3B, the process 308 for computing the join fanout for two histogram buckets in tables R and S, begins in step 320 in which it is determined whether there are any matching frequent values identified by data structures 210 in the two histogram indexes. If there are matching frequent values in the histogram buckets, then in step 322 two matching values are selected and the frequencies for those two matching values are multiplied. The product of their frequencies is then added to the join fanout estimate. Next, in step 324, it is determined whether there are any additional matching values in the buckets being evaluated. If so, then processing returns to step 322 and the frequencies of these additional matching frequent values are multiplied and the product is added to the fanout estimate. Steps 322 and 324 are repeated until all matching frequent values in the two histogram indexes have been processed, at which time the join fanout computation continues to step 326.

As an example of this process, in the histogram index of FIGS. 2A and 2B, there are two matching frequent values, ABDO and CURT. The frequencies of ABDO are 81 and 123, so in step 322, 81 is multiplied by 123 to produce a fanout of 9963 which is added to the current fanout estimate. In the next pass through step 322, the frequencies of CURT, 56 and 623, are multiplied, to produce a fanout of 34888. This fanout is also added to the join fanout estimate. As a consequence, the join fanout estimate is increased by a total of 44851. After thus using frequent values to compute the join fanout, those values which appear as frequent values in one table's histogram, but do not appear as frequent values in the other table's histogram, are evaluated to compute estimates of join fanout as to those values. This process proceeds by estimating the average frequency of values in the A-D bucket of attribute Y in table S, that do not appear in the frequent values list for the A-D bucket of attribute Y of table S. For this calculation, it is assumed that all distinct values in a bucket which are not frequent values, have approximately equal frequency. Thus, the frequency of any value in a bucket that does not appear in the frequent value list, can be computed by: subtracting from the total number of values in the histogram bucket, the number of values which appear in frequent value data structures; subtracting from the number of distinct values for a bucket, the number of frequent values identified for that bucket; then dividing the remaining number of values by the remaining number of distinct values to produce an estimate of the number of times each infrequent value appears in the bucket.

Thus, in the example of FIG. 2B, the estimate of the number of times each infrequent value appears in the A-D bucket of table S, is computed by subtracting the number of occurrences of frequent values, from the 2400 total values in the bucket. 2400 minus 123 minus 1746 minus 56 minus 121 yields 354 infrequent values appearing in the A-D bucket in table S. Next, the number of distinct values (76) in the A-D bucket of table S, is reduced by four to 72, because there are four frequent values identified in the A-D bucket's data structures 210 in table S. Finally, an estimate of number of times that all infrequent values appear in table S is computed by dividing 354 by 72, which produces an estimate of 4.9, which can be rounded to five.

Thus, the number of times an infrequent value is estimated to appear in the A-D bucket in table S is five times. Using this estimate, the fanout of the unmatched frequent values of table R can be estimated by multiplying the frequencies of those frequent values in table R by the average frequency estimated for infrequent values in table S. Thus, the fanout for the frequent value AL in table R is estimated to be 550 times 5 equals 2750. A similar calculation is made is for each other frequent value in table R in the A-D bucket that was not matched to a frequent value in table S in the A-D bucket. The products generated in this step 326 are then added to the total join fanout estimate.

Subsequent to step 326, a similar step 328 is performed to estimate the average frequency of infrequent values in table R, by a method identical to that used above to estimate the frequency of infrequent values in table S. This computation yields a total of 716 infrequent values in table R, 30 distinct values in these infrequent values, and an average of 24 appearances for each infrequent value in R. Then the fanout caused by unmatched frequent values from the A-D bucket in table S, is computed by multiplying the frequencies of the unmatched frequent values in table S by the estimated 24 appearances of each infrequent value in table R. These products are then also added to the fanout estimate to complete step 328.

The foregoing steps produce fanout estimates for frequent values appearing in both tables in the current bucket, as well as frequent values that occur in one table but which are not frequent values in the opposite table. The remaining fanout estimation is performed using equation (1) described in the background of this application. Specifically, the number of values that remain in each table after removing the values that have been previously evaluated, is computed to produce the numbers T(R) and T(S) for use in equation (1). The number of distinct values V(R,Y) or V(S,Y) is computed by subtracting from the number of distinct values for a bucket, the number values 110 that have been previously evaluated. In step 330, applying the formula from equation 1 in the background of this application, results in an estimate of fanout for those infrequent values in tables R and S which have not previously been evaluated. This estimate is then added to the fanout estimate accumulated through the proceeding steps 326 and 328.

In the illustrated example, this estimate for the join fanout for infrequent values would be computed as:

$$\frac{( 716 - 2 \times 24 ) * ( 354 - 2 \times 5 )}{Max ( 34 - 6 , 76 - 6 )} = 3283.$$

Note in this example that the previously-computed 716 infrequent values in the A-D bucket of relation R, has been reduced by 2×24, reflecting the calculation in step 328 which accounts for the fanout of the two unmatched frequent values in table S (DAN and ANDY), and estimates that each appears 24 times in table R. Similarly, the previously-computed number of 354 infrequent values in the A-D bucket of relation S, has been reduced by 2×5, reflecting the calculation in step 326 which accounts for the fanout of the two unmatched frequent values in table R (AL and DOUG), and estimates that each appears 5 times in table S. Note also, that the 34 distinct values in table R has been reduced by 6 to obtain V(R,Y)=28, reflecting that the fanout of the four known frequent values of R, as well as two frequent values from table S assumed to also be infrequent values of R, were already included in the computation. Similarly, the 76 distinct values in table S has been reduced by 6 to obtain V(S,Y)=70, reflecting that the fanout of four known frequent values of S, as well as two frequent values from table R assumed to also be infrequent values of table S, were already included in the computation.

As noted above, steps 322 and 324 are only performed if there are matching frequent values in the bucket being evaluated. If there are no matching frequent values, these steps are skipped and processing proceeds directly from 320 to step 326 and then through step 326 to steps 328 and 330 to produce a join fanout estimate.

The complexity of the algorithm described in FIGS. 3A and 3B is order O(M×N), where M is the number of buckets in the histograms indexes and N is the maximum number of frequent values that are identified for each bucket. This complexity is low when considered in view of the advantages of the present invention in comparison to traditional formula based methods for computing join fanout. Specifically, the present invention captures frequency distributions of joined attributes, it can be extended to handle inequality join predicates, and it can apply selection to the join attribute without the effecting the accuracy of the join fanout estimate.

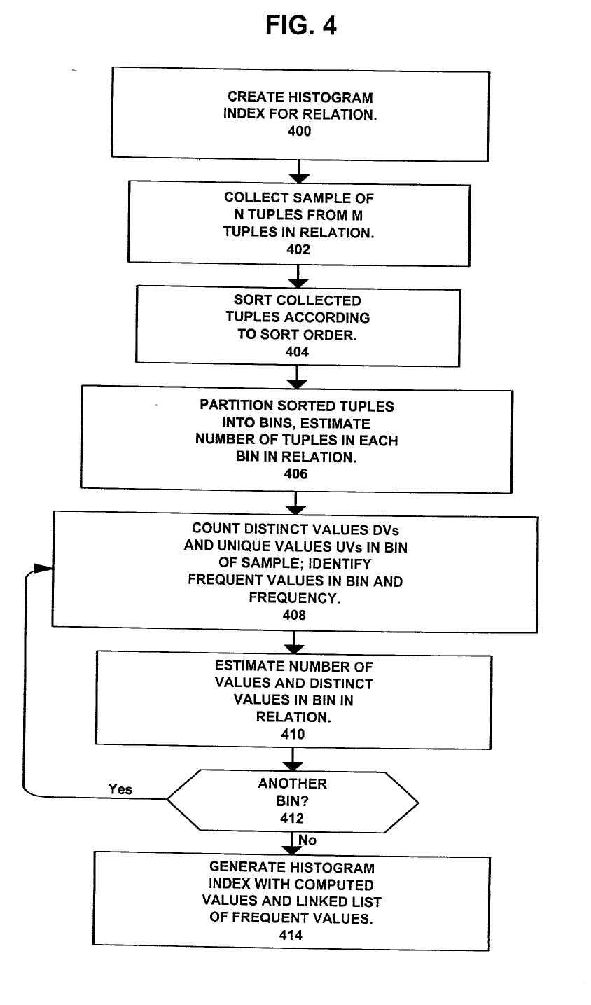

Referring now to FIG. 4, the process 400 for generating a histogram index for a relation can be explained. In a first step 402, a sample of N tuples (rows) is gathered by random selection from the total of M tuples (rows) in relation. The number of tuples N in the sample is chosen to be representative of the entire relation, using known sampling estimation techniques.

Next, in step 404, the collected tuples are sorted on the attribute of interest using the sort order to be used in the histogram, and in step 406, the sorted tuples are then partitioned into the defined bins and an estimate is made of the number of values in the relation that falls within each bin. This estimate is generated by multiplying the number of values in the bin in the sample, by the factor M/N (the ratio of the total number of tuples to the number of tuples in the sample).

Next, for each bin, steps 408 and 410 are performed. In step 408, the tuples in a bin of the sample are scanned to count the number of distinct values DVs in the bin in the sample (i.e., the number of different values that appear in the attribute of interest in the bin in the sample), as well as the number of unique values UVs in the bin in the sample (i.e., the number of values that appear only once in the attribute of interest in the bin in the sample). Furthermore, the most frequent values are identified and the number of appearances of those frequent values is collected. The number of appearances of these frequent values in the entire relation is estimated from the number of appearances of those values in the sample, by multiplying the counted number of appearances of the frequent values in the sample by the factor M/N.

Next, in step 410, the number of distinct values in the entire relation is estimated from the accumulated counts of distinct values and unique values in the sample. The estimate of the number of distinct values in the relation, is obtained from the sample using the known formula

$${DV}_{r} = \frac{DVs}{[ 1 - \frac{[ 1 - N / M ] UVs}{N} ]} \qquad ( 3 )$$

where DVr is the number of distinct values in the relation, DVs is the number of distinct values in the sample, N is the number of tuples in the sample, M is the total number of tuples in the relation, and UVs is the number of unique values identified in the sample.

After completing steps 408 and 410 for a bin, in step 412 it is determined whether there are additional bins to be evaluated. If so, processing returns to step 408 to evaluate the next bin. When all bins are completed, all of the information needed for the histogram index is computed, so processing continues from step 412 to step 414, where the index is generated using the data structures as described with reference to FIGS. 2A and 2B, and inserting the computed values for DVr and N for each bin, and identifying the frequent values and their estimated frequencies.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method for estimating statistics on an attribute of a relation, comprising
forming a histogram of said attribute of said relation, the histogram being augmented to identify the most frequent values of an attribute,
evaluating said histogram in connection with a criterion for retrieval of data from a relation.

2. The method of claim 1 further comprising forming a second histogram of said attribute of a second relation, said second histogram being augmented to identify the most frequent values of said attribute, and
evaluating said histograms to identify frequent values shared by said histograms.

3. The method of claim 2, further comprising multiplying frequent values in each of said histograms to produce a estimate of join fanout of a join of said relations on said attribute.

4. The method of claim 3, further comprising multiplying a number of a frequent value in one said histogram by an estimate of the average number infrequent values in the other histogram.

5. The method of claim 3 further comprising computing a number of matching infrequent values in each said histogram by
estimating a number of infrequent values in each relation using said histograms, and
computing from said estimates the join fanout attributable to said attribute.

6. A computer system for implementing a relational database system and performing a user query on said relational database system, comprising
storage for relations of said relational database system, and a histogram of an attribute of a first of said relations, the histogram being augmented to identify the most frequent values of an attribute in said first relation,
a computing circuit for implementing said relational database system, said computing circuit computing a statistic on said attribute by evaluating said histogram in connection with a criterion for retrieval of data from a relation.

7. The computer system of claim 6 wherein
said storage further includes a second histogram of said attribute of a second of said relations, said histogram being augmented to identify the most frequent values of said attribute in said second relation, and
said computing circuit evaluates said histograms to identify frequent values shared by said histograms.

8. The computer system of claim 7 wherein
said computing circuit multiplies frequent values in each of said histograms to produce a estimate of join fanout of a join of said relations on said attribute.

9. The computer system of claim 8 wherein
said computing circuit multiplies a number of a frequent value in one said histogram by an estimate of the average number infrequent values in the other histogram.

10. The computer system of claim 8 wherein
said computer system further computes a number of matching infrequent values in each said histogram by estimating a number of infrequent values in each relation using said histograms, and computing from said estimates the join fanout attributable to said attribute.

11. A program product for estimating statistics on an attribute of a relation, comprising
a program of instructions executable on a computer system to form a histogram of said attribute of said relation, the histogram being augmented to identify the most frequent values of an attribute, and evaluate said histogram in connection with a criterion for retrieval of data from a relation, and
a signal bearing medium bearing the program.

12. The program product of claim 11 wherein said program further comprises instructions for forming a second histogram of said attribute of a second relation, said second histogram being augmented to identify the most frequent values of said attribute, and evaluating said histograms to identify frequent values shared by said histograms.

13. The program product of claim 12, wherein said program further comprises instructions for multiplying frequent values in each of said histograms to produce a estimate of join fanout of a join of said relations on said attribute.

14. The program product of claim 13, wherein said program further comprises instructions for multiplying a number of a frequent value in one said histogram by an estimate of the average number infrequent values in the other histogram.

15. The program product of claim 13 wherein said program further comprises instructions for computing a number of matching infrequent values in each said histogram by
estimating a number of infrequent values in each relation using said histograms, and
computing from said estimates the join fanout attributable to said attribute.

16. The program product of claim 11 wherein said signal bearing medium is a recordable medium.

17. The program product of claim 11 wherein said signal bearing medium is a transmission-type medium.
